(19) United States
(12) Patent Application Publication
(10) Pub. No.: US 2002/0007291 A1
(43) Pub. Date: Jan. 17, 2002

(54) Method for the automation of allocation processes for products and/or services

(76) Inventors: Norbert Miller, Monchengladbach (DE); Markus Schneider, Alsdorf (DE)

Correspondence Address: Michael A. Cantor, Esq., CANTOR COLBURN LLP, 55 Griffin Road South, Bloomfield, CT, 06002, US

(21) Appl. No.: 09/769,829

(22) Filed: Jan. 24, 2001

(30) Foreign Application Priority Data
Jan. 24, 2000 (ER) 00101350.7

(51) Int. Cl. G06F 17/60

(52) U.S. Cl. 705/5

(57) ABSTRACT

A method for the automation of availability-checking, reservation and allocation/assignment processes for localized products and/or services, under utilization of a supraregional communications link and on the basis of a user's requirements, including: a) the user selecting a provider's product or service; b) the user transmitting an identification code; c) the provider reserving the item, storing the identification code, and forwarding a reservation and code information to a code verification system, under utilization of a local-area communications link; d) triggering a non-contact, proximity code verification when the user enters within a range of the code verification system; and e) granting an access to the user upon a positive code verification.

This invention relates to a method for the automation of availability-checking, reservation and correlative identification and allocation processes for localized products and/or services.

In the service sector, extensive automation efforts have already been made and implemented. It is especially for the type of services that is adaptable to any given user group that the allocation of use privileges is to be made as simple and automated as conceivably possible. For example, there already exist semiautomatic use-authorization systems for issuing airline and railroad tickets, parking-garage and recreational-facility permits and the like. But in the realm of product dispensing as well, simplification efforts are afoot, following the example for instance of those so-called drive-ins and similar systems.

In the final analysis, however, prior-art systems are still unable to do without the exchange or transfer of documents such as printed authorization certificates and similar permits. This is due primarily to the fact that a uniquely individualized user identification is not possible. With semiautomatic systems, for instance those used in the issuance of airline tickets, reference is made to a special, provider-issued charge card or, most commonly, to a credit-card number, whereby the presentation of the special charge or credit card, or its insertion in a machine, results in the print-out of a ticket. All of these earlier, specialized system are for the most part mutually incompatible and uneconomical since they require numerous special devices, each customized for one particular purpose. Moreover, the user has to keep handy numerous documents, cards and the like and for every use he always ends up having to manually perform individual steps, for instance collecting or pulling out a parking-garage ticket, or printing out a travel ticket etc. Besides, most of the prior-art systems are not capable of also performing in fully automatic fashion such immediate follow-up steps as the automated generation of accounting statements.

It is therefore the objective of this invention to introduce a method in this general category which is easily adaptable to a large variety of applications, is automatically implementable and which, most of all, is as simplified for the user as is conceivably possible.

The invention also specifies systems for applying the method here disclosed.

For the technical solution, this invention proposes a method for the automation of availability-checking, reservation and correlative allocation processes for localized products and/or services, with the aid of a supraregional communications link and based on a user's requirement.

According to the method,

a) the user selects a provider's product item,

b) the user transmits an identificaton code,

c) the provider reserves a selected item, stores the identification code, and feeds a reservation and code information to a code verification system, under utilization of a local-area communications link,

d) a non-contact proximity code verification takes place as the user enters within a range of the code verification system, and

e) upon positive code verification, the user is granted access.

In the context of this invention, the term supraregional communications link refers to any existing or potential communication system that is preferably suitable for digital data transmission over great distances. At this juncture, this would include for instance wireless mobile phone networks. In particular, the supraregional communication between the user and the provider will involve the use of mobile communications transmitters, for instance cell phones, palmtops and the like. At least for the user, the utilization of a mobile communications transmitter is an important aspect in the simplification of the system's deployment since it is possible for the user to access localized products and/or services virtually from anywhere in the area.

The term localized products and/or services, in the context of this invention, refers to products which can be received at specified locations or at a specific type of locations, or to services which are available at specified locations or at a specific type of locations. Accordingly, products or services can be made available at several distribution points. As an example, in response to a supraregional request a bus or train permit can be issued at different boarding points.

The request for a product or service may be made based on a user's specific requirement or with reference to an assortment of generally available offerings. When a user has a specific requirement, for instance when he wants a parking space in a parking garage, he will dial up the corresponding parking-garage system and communicate with it regarding the transaction, thus applying the method within the scope of this invention by virtue of the user's initiative. Conversely, the provider may offer a range of available products or services, enabling the customers to familiarize themselves with, and select from, the offering. The process of matching demand and supply may include an adjustment that involves several communication steps. For example, when applying the method to travel, the user's desired points of departure and arrival would be reconciled with what the providing carrier has to offer.

Once the user has expressed his interest via the supraregional communications system, employing any potential mode of transmission, for instance in digital form employing a GPS/SMS system, GPRS, UMTS, the Internet, using for instance a so-called WAP connection or even voice mail, to be digitized and analyzed for instance in the provider's mainframe, the provider will use its database or similar inventory control system for an availability check. For example, in a parking garage employing local monitoring systems, a check would be made for an available parking space or a database simulation would determine and evaluate the current capacity. Where the product or service is available, the provider can satisfy the requirement. On the other hand, no availability check is needed in cases where no specific one-time requirement is involved, for instance when a general permit or time pass for local transportation etc. is to be purchased.

As soon as the potential user has received a confirmation to the effect that his requirement can be met, he can acknowledge and accept the offer and a code can be transmitted. The process may involve separate steps or one standardized combination step. For example, the active transmission of a code can at the same time constitute the acceptance of the offer.

The code may be generated in various ways. According to one proposed approach per this invention, the code can be generated manually as a character combination keyed in by the user. At the same time it may be desirable to also store the code in the user's mobile phone as a reminder or for reuse at a later date. ID codes can also be generated automatically or retrieved from a storage device and transmitted. It would be possible to use for instance the mobile-phone ID, the telephone number, telephone details such as serial number, or other device-identifying, electronically device-retrievable data such as details from the telephone calling card, the PIN or data from the telephone directory in the user's terminal.

At the provider's end the identification code assigned to the user is stored and fed into a device which is capable of communicating in proximity fashion, i.e. wireless and non-contact, with a user-held unit for retrieving the code stored therein, comparing it with the provider's assigned code or routing it to a comparator for verification.

At the user's end, the code identification system consists of a unit in which a code, personalized and exclusively assigned to the specific user, is stored. This unit can present the code for non-contact scanning, preferably by both the supraregional communications system at the users end and by the code verification system at the provider's end. The code may be composed of digital characters which can be transmitted in non-contact fashion by way of various digital transmission carriers such as digital radio systems, optical links etc.

Code verification becomes possible as soon as a user enters the local area of the provider's verification unit. For the purpose of this invention, the term local area refers to an area extending over a short distance from the verification unit and enabling the verification unit to communicate with the code unit at the user's end.

Within the local area, communication takes place between the code verification system and the user via a local communications link. Such local communications links may be in the form of short-range radio systems, optical communications systems etc. Short-range radio or so-called Blue Tooth systems can be used for instance to complement mobile phone systems. Optical systems may be infrared links or the like. Depending on the application concerned, different local communications systems may be needed so as to also meet other requirements. Local communications systems can also be implemented by assembling and employing mobile radio telephone links.

When on the basis of the local-area communication the provider's system is enabled to perform code verification, use and access authorization can be given. For example, parking-garage gates can be opened, product-release systems activated or controlled areas opened for access by the user. Stored authorizations can be reviewed, for instance for the automatic determination whether the person to whom the identification code was assigned is authorized to take a particular flight, to receive a particular product, etc. The method according to this invention is based on the individually personalized association of the user with an identification code. Utilizing supraregional data telecommunications systems, a code, assigned and stored by the provider for a product or service or point of use, can be transmitted for nearly any application. The local-area communication then determines whether the code-transmitting person is authorized to receive the product or to use the service concerned. This is referred to as a White List or Positive List system.

Based on the personalized assignment of the user code, the system according to this invention can be expanded in simple fashion into an automated billing system. By way of the personalized association, the process can be linked with credit-card systems, centralized accounting systems such as the mobile phone service providers' accounting systems, a billing system based on stored billing information, or the provider's own user credit system.

The range of possible applications of the method according to this invention is extremely multifaceted and virtually inexhaustible. Examples include uses in parking-garage systems, at gas-station fuel pumps, at controlled-access facilities, in public commuter transportation as well as in long-distance carrier service including air travel, ferry service, at recreational facilities etc., but also in the realm of consumer products as for instance in the case of drive-in food pick-up systems especially in the fast-food market, and other products as well. Conceivably, it should be possible to store at the distribution or shipping point of warehouses merchandise ordered via telecommunication links for release on presentation of an authorization code transmitted through the local communications link.

The method according to this invention also allows for a permanent user authorization, whereby an authorization code, once assigned, can be permanently stored, routinely releasing the access and/or use permit whenever the authorization code is recognized in the local-area communication process.

Details of the method according to this invention and of the equipment-related features of the invention are provided in the following description of one applicational example and with the aid of the diagram where:

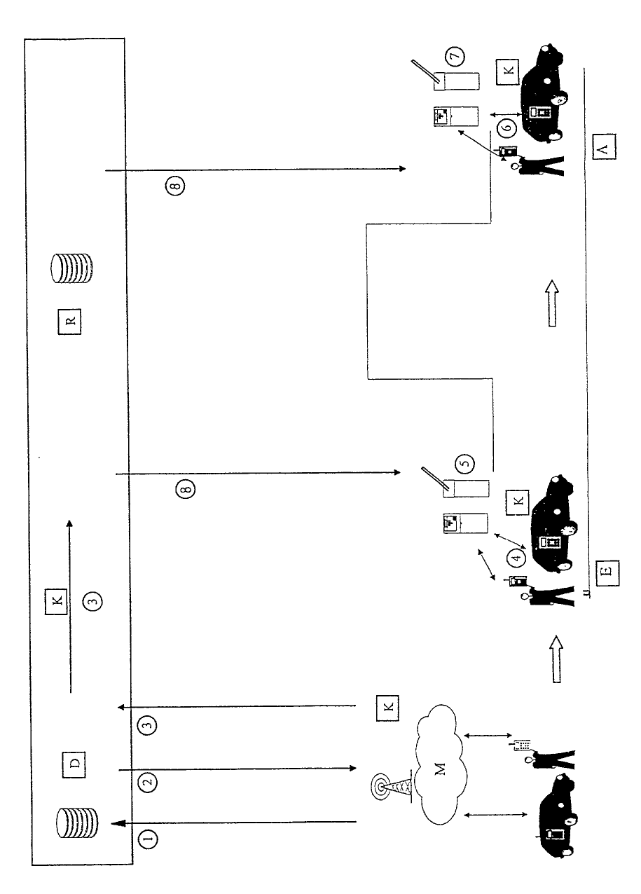

FIG. 1 is a schematic illustration of an implementation example of this invention.

The applicational example relates to the transaction of a parking-space allocation in a parking garage.

The starting scenario may vary. The user may know of his need for a parking space in a parking garage, perhaps in a different town, well in advance. Or a person may realize that need at very short notice and may be looking for a suitable parking garage with parking space. This invention can provide for direct communication with the parking-garage system via a central parking-garage referral service enabling the user to locate the nearest parking garage with available space without being familiar with that specific garage.

As soon as the user, having a particular requirement or having various options, has established contact with the parking-garage system via his mobile phone and the mobile radio telephone network M, the parking-garage operator's computer detects the enquiry 1 and performs an availability check. That computer may be a networked system or a stand-alone computer. The computer has a data telecommunications interface and appropriate systems for the analysis of the incoming data. The computer is also equipped with systems for checking on the available parking spaces and for determining whether or not a specific parking space can be offered. After the completed availability check D the computer issues to the user a signal 2 with a corresponding offer via the data telecommunications link. The user can now accept the offer. This he does by sending a corresponding signal 3. This signal 3, symbolizing acceptance of the offer, can be sent separately or in direct conjunction with the transmission of the user's identification code K. If the user's communications transmitter also contains an integrated local-area communications unit with a corresponding code K, the telecommunications system, in the case of this particular example the mobile radio telephone system M, automatically transmits the code K which is also available for use by the local-area communication system. This local-area communications link may be for instance a so-called Blue Tooth, meaning a separate short-range radio unit. Alternatively it may also be an infrared link or some other interface for the optical transmission of the code.

The provider's system now establishes that, for a particular code, a specific parking space or choice of parking spaces is available. The provider's computer transmits this information to the access verification system.

In addition, as part of the process, the user may be given directions. For example, if the user's exact location is known, the provider's computer can send him appropriate routing information. The user's location can be determined in different ways. For example, the user's system may be GPS-equipped, or the mobile-phone service provider who usually knows the precise point of origin of a cell-phone call to within a very short distance provides this geographic information. Given the user's location and his destination, a computer can now determine, and relay to the user, the best way to the destination point in due consideration of infrastructural circumstances, perhaps even of current traffic conditions, information on road-construction projects etc. The route display on the user's terminal may be in the form of arrow symbols, road maps, graphic illustrations or the like.

Once the user enters the local area of the parking garage and in particular the local area of the parking-garage entrance ramp equipped with access control systems, the system checks whether local-area communication 4 can be established. Desirably, the parking-garage operators will arrange for separate access lanes to reserved parking spaces to avoid backup delays. The parking garage can also identify areas in which local communication 4 is possible by means of signals or visual markers.

As soon as the user has entered the local communications area, local communication 4 is established between the user's communication terminal and the communication device of the parking garage in the access gate area. This may be initiated by an activating signal issued by the parking garage or a special activating signal transmitted by the user. As soon as the two systems begin to communicate, the parking-garage system asks for the code K and/or the user's system automatically transmits its code K. The parking-garage devices are connected to the computer system via a network or again by way of a wireless radio system and will now check on the assignment of the code K and the appropriate authorization. In the case of this example, a matching code will open the gate %.

Concurrently, the information needed for the subsequent integration of an automated accounting system, such as the time of the code-enabled entry, can be acquired and stored and/or forwarded to a computer system.

For exiting, code verification 6 can again take place, opening the exit gate 7 for the user.

The integration into an automated accounting and billing system can be accomplished in different ways. For example, based either on a generally instituted correlative system or on the parking garage's in-house code referencing system for direct charges to a credit card service or to the accounting system of the mobile telephone service, the charges can be booked automatically based on the length of the time the parking space was used.

Automatic billing is equally possible, or automatic debiting against a specific pre-arranged parking-garage or a general deposit scheme.

Instead of using a Blue Tooth for the local radio link, the communications terminal could conceivably be equipped with optical transmission ports for communicating with corresponding optical systems of the parking garage. This could involve the use of infrared interfaces, optical pulse signal transmission and the like. In general it is also possible to operate the code detection system altogether separately from the communication terminal. In that case it will be necessary to enable the mobile phone terminal, upon accepting the product or service offer, to transmit the identification code without, however, using the communications terminal in the verification process. In this case an additional device may be employed for code verification. An additional device of that nature offers an advantage in that it can be operated independent of the functional status of the mobile radio telephone device.

The ticketing method according to this invention provides for an identification code to be assigned to an authorization package, as explained in the example of a travel permit. The object may be a season ticket such as a monthly travel permit, or the application may be altogether different, for instance a regular admission ticket, an access permit etc.

The application example described is intended for explanatory purposes only and is not limiting in nature. The equipment features specified relate to a system at the provider's end which is implemented either in separate subsystems or as an integrated system both for supraregional data telecommunications and for local operation. Also required at the provider's end is a computer capable of handling centralized activities, such as availability checks and perhaps accounting and billing, as well as distributed functions such as authorization verification and the like. The user needs to be equipped with a communications terminal for supraregional, remote data transfer, plus a unit for proximity-operated local communication to permit authorization verification.

### Reference List

1 Enquiry

2 Offer

3 Acceptance of Offer

4 Local-Area Communication

5 Access Gate

6 Local-Area Communication

7 Exit Gate

8 ID Code Verification

M Mobile Radio Phone Network

K Identification Code

D Offer / Availability Check

R Code and Reservation Information

E Access Ramp

A Exit Ramp

1. Method for the automation of availability-checking, reservation and allocation processes for localized products and/or services, under utilization of a supraregional communications link and on the basis of a user's requirement, the method comprising:
a) the user selecting a provider's product or service;
b) the user transmitting an identification code;
c) the provider reserving a selected item, storing the identification code, and forwarding a reservation and code information to a code verification system, under utilization of a local-area communications link;
d) triggering a non-contact, proximity code verification when the user enters within a range of the code verification system; and
e) granting an access to the user upon a positive code verification.

2. Method as in claim 1, characterized in that the supraregional communications link is a mobile radio telephone network system.

3. Method as in one of the preceding claims, characterized in that the local-area communications link is a mobile radio telephone network system.

4. Method as in one of the preceding claims, characterized in that the local-area communications link is a local-area radio network.

5. Method as in one of the preceding claims, characterized in that the identification code for a particular use is issued for a limited area or time.

6. Method as in one of the preceding claims, characterized in that the local-area communications link is enabled by the user.

7. Method as in one of the preceding claims, characterized in that the non-contact code verification is accomplished by optical means.

8. Method as in one of the preceding claims, characterized in that the code provided by the user for transmission and/or verification purposes is released by a selective activation.

9. Method as in one of the preceding claims, characterized in that the data-transfer, availability-checking, reservation and allocation or assignment processes are performed with an aid of a central mainframe processing system.

10. Method as in claim 9, characterized in that the central mainframe processing system is equipped with data telecommunications interfaces as well as systems for enquiry analysis, availability checking, the generation and transmission of product or service offers, code acceptance and storage, communication with code verification and/or access authorization systems and perhaps point-of-sale management units.

11. Method as in one of the preceding claims, characterized in that the user employs the method for reserving parking space in park garage systems and obtaining access to the parking space thus reserved.

12. Method as in one of the preceding claims, characterized in that, under utilization of a code and of an information related to its use, an accounting statement is automatically generated.
